(19) United States
(12) Patent Application Publication
(10) Pub. No.: US 2026/0346709 A1
(43) Pub. Date: Nov. 5, 2026

(54) STEERING WHEEL ELEMENT FOR DETECTING TOUCH-BASED INPUTS AND ZONAL REASSIGNMENT OF CONTROL SIGNALS WITH STEERING WHEEL ROTATIONAL DISPLACEMENT

(71) Applicant: Bradley Davis, Franklin Lakes, NJ (US)

(72) Inventor: Bradley Davis, Franklin Lakes, NJ (US)

(21) Appl. No.: 19/650,322

(22) Filed: Apr. 16, 2026

Related U.S. Application Data
(60) Provisional application No. 63/789,958, filed on Apr. 16, 2025.
(60) Provisional application No. 63/843,955, filed on Jul. 14, 2025.
(60) Provisional application No. 63/880,722, filed on Sep. 12, 2025.

(51) Int. Cl. B60K 35/10; B60K 35/22; B62D 1/04; B62D 1/06; B62D 15/02

(52) U.S. Cl. CPC B60K 35/10; B60K 35/22; B62D 1/046; B62D 1/06; B62D 15/022

(57) ABSTRACT

In one aspect, a steering wheel assembly is provided which includes: a steering wheel, wherein a series of stationary virtual zones encircle the steering wheel; a touch-detectable steering wheel element mounted on, or integrated with, the steering wheel; a detector configured to detect angular displacement of the steering wheel; and a central processor. The touch-detectable steering wheel element includes a plurality of zones configured to independently detect contact by a user, the plurality of zones being movable relative to the virtual zones with angular displacement of the steering wheel. A first output signal is associated with a target virtual zone. The central processor identifies an active zone, based on its alignment with the target virtual zone, and associates the active zone with the first output signal such that contact by the user of the active zone in a predetermined manner results in generation of the first output signal.

### CROSS-REFERENCES TO RELATED APPLICATIONS

This application claims priority to each of: U.S. Provisional Patent Appl. No. 63/789,958, filed Apr. 16, 2025; U.S. Provisional Patent Appl. No. 63/843,955, filed Jul. 14, 2025; and U.S. Provisional Patent Appl. No. 63/880,722, filed Sep. 12, 2025. The entire contents of these filings are incorporated by reference herein.

### FIELD OF THE INVENTION

The present invention relates to steering wheels, more particularly, steering wheels configured to detect touch-based inputs.

### BACKGROUND

Steering wheel grip sensors are known in the prior art. U.S. Pat. No. 11,015,990, to the inventor herein, discloses a grip sensor useable on a steering wheel which is capable of detecting the extent of engagement of a steering wheel by a driver while actively driving. The disclosure of U.S. Pat. No. 11,015,990 is incorporated by reference herein.

In addition, steering wheels have been configured in the prior art to include interfaces for accepting inputs to control various features of a vehicle, such as controlling a vehicle's radio or entertainment system (e.g., volume controls, pause/play, etc.), controlling a vehicle's display (e.g., toggling between dashboard screens, control overhead display, etc.), controlling vehicle elements (e.g., windshield wipers, climatic control, etc.), and/or controlling communication with third parties outside the vehicle (e.g., wireless control over a telephone, emergency signaling, etc.). Generally, these interfaces are responsive to touch, pressure, adjustment, or other physical contact, e.g., being in the form such as, pressable buttons, touch pads, toggle switches, rotatable switches, and so forth.

U.S. Pat. No. 8,886,407 discloses a steering wheel input device which has gesture recognition and angle compensation capabilities. With this arrangement, gestures along a central pointer detection surface may be angularly compensated, thereby, allowing for angular compensation for a gesture across the pointer detection surface. For example, without compensation, a rightward swipe on a turned steering wheel may be interpreted as a vertically upward swipe since the vertical axis of the pointer detection surface is angularly out of alignment with a vertical axis intersecting the steering wheel. The arrangement of U.S. Pat. No. 8,886,407 provides angular compensation to recognize the orientation of the gesture relative to the vertical axis intersecting the steering wheel.

U.S. Pat. No. 12,032,817 discloses a touch-sensitive steering wheel configured to detect a series of gestures, and locations of the gestures, to activate or deactivate autonomous driving of a vehicle. The locations of the gestures are identified by standard clock face positions (one o'clock, two o'clock, etc.) without any modifications or adjustments based on steering wheel orientation.

### SUMMARY OF THE INVENTION

In one aspect, a method of accepting user inputs on a steering wheel assembly during use is provided, the steering wheel assembly including a touch-detectable steering wheel element mounted on, or integrated with, a steering wheel, the method including: associating a first output signal with i. a first intended effect and ii. one or more contact gestures; associating the first output signal with a first clock position relative to the steering wheel; continuously monitoring angular displacement of the steering wheel during use; iteratively identifying, based on angular displacement of the steering wheel, a currently active zone of the touch-detectable steering wheel element which is, at a given moment, in alignment with the first clock position; and, upon being identified, associating the currently active zone with the first output signal such that application of the one or more contact gestures by the user within the currently active zone is translatable into generation of the first output signal.

In a further aspect, a steering wheel assembly is provided herein which includes: a rotatable steering wheel, wherein a series of stationary virtual zones encircle the steering wheel; a touch-detectable steering wheel element mounted on, or integrated with, the steering wheel, wherein the touch-detectable steering wheel element includes a plurality of sensors configured to detect contact of the touch-detectable steering wheel element by a user, the plurality of sensors being divided into a plurality of zones configured to independently detect contact by a user, the plurality of zones being movable relative to the virtual zones with angular displacement of the steering wheel; a detector configured to detect angular displacement of the steering wheel; and, a central processor configured to: i. at initiation of a session of use of the steering wheel, determine which of the plurality of zones is initially associated with a first virtual zone of the virtual zones by one of: a. identifying an initially-associated zone as the zone of the plurality of zones which is aligned with the first virtual zone at the initiation of the session; or, b. identifying an initially-associated zone based on a predefined default setting; wherein, a first output signal is associated with the first virtual zone; and, wherein, the initially-associated zone is associated with the first output signal, to the exclusion of the other zones, such that contact by the user of the initially-aligned zone in a predetermined manner is translatable into generation of the first output signal; and, ii. during the session of use of the steering wheel, based on the detected angular displacement of the steering wheel, identify a currently active zone, the currently active zone being identified as the zone from the plurality of zones aligned, at the moment, with the first virtual zone, wherein, upon the currently active zone being identified, the currently active zone is associated with the first output signal, to the exclusion of the other zones, such that contact by the user of the currently active zone in the predetermined manner is translatable into generation of the first output signal.

Advantageously, the subject invention provides a touch-detectable steering wheel useable as an user interface which includes zonal reassignment of control signals based on steering wheel rotational displacement. The subject invention allows for discrete locations on a steering wheel to be input locations independent of steering wheel rotational positioning.

### BRIEF DESCRIPTION OF THE DRAWINGS

FIGS. 1-10 show a steering wheel assembly formed in accordance with the subjection invention;

FIGS. 11a-12 show an arrangement useable with the subjection invention for detecting touch-based inputs by a user;

FIGS. 13a-14 show an alternate arrangement useable with the subject invention for detecting touch-based inputs by a user;

FIGS. 15a-15b show schematically multi-figure contact useable with the subject invention;

FIGS. 16a-16b show schematically swiping contact useable with the subject invention;

FIGS. 17a-17b show schematically hand or palm contact useable with the subject invention;

FIGS. 18a-18b show schematically one-finger contact useable with the subject invention;

FIGS. 19a-20b show schematically two-finger magnification and contraction contacts useable with the subject invention;

FIGS. 21a-21b show schematically one-finger tapping contact useable with the subject invention;

FIGS. 22a-22b show schematically multi-finger tapping contact useable with the subject invention;

FIGS. 23-28 show a further alternate arrangement useable with the subject invention for detecting touch-based inputs by a user;

FIGS. 29-30 schematically show arrangements of zones useable with the subject invention;

FIG. 31 is a flow chart of a method useable to accept user inputs on a steering wheel assembly and zonal reassignment in accordance with the subjection invention;

FIG. 32 is a flow chart of a method for zonal reassignment useable with the subject invention;

FIGS. 33-36 are representative examples of zonal reassignment in accordance with the subject invention;

FIG. 37 is a schematic of an arrangement of regions designated for different actions useable with the subject invention;

FIG. 38 is a schematic of stationary virtual zones depicted about a steering wheel in accordance with the subject invention; and,

FIG. 39 is a schematic of the central processor in accordance with the subject invention.

### DETAILED DESCRIPTION

With reference to the subject invention, a touch-detectable steering wheel element is provided configured as an input device. The touch-detectable steering wheel element is configured to detect touch-based inputs from a user to generate output signal(s). This touch detection may be additionally used to sense the level or extent of grip of a driver, as described in U.S. Pat. No. 11,015,990. The touch-detectable steering wheel element may be provided without grip sensing.

The touch-detectable steering wheel element may be responsive to various touches or gestures (swiping, tapping, grasping, pressing) as inputs which may be defined by movement by finger(s), number of touches, and/or length of touch (distance, duration). Particular touches or gestures may be mapped to particular actions to permit control over various intended effects. In this way, the touch-detectable steering wheel element may act to facilitate conversion of detected touches into a plurality of different output signals useable in connection with various features or elements, such as features of the vehicle (e.g., control over navigation system, entertainment system, such as radio, streaming music, ebooks, and so forth (e.g., control over volume, selecting, skipping, pausing/unpausing, muting/unmuting, changing channels, etc.)); control over vehicle display(s) (e.g., overhead display, dashboard display, and so forth (e.g., toggling between dashboard screens, control over overhead display, etc.)); control over vehicle element(s) (e.g., windshield wipers, climate control, interior lighting, head lights, cruise control, etc.)); and/or, communication with third parties outside the vehicle (e.g., cellular communication, texting, VOIP calling, distress signaling, and so forth (e.g., wireless control over a telephone, emergency signaling, etc.)). In addition, a detector configured to detect angular displacement of the steering wheel, e.g., an inertial measurement unit (IMU), may be provided with the touch-detectable steering wheel. The detector may be used to determine an angular displacement of the steering wheel. In addition, the detector may be used to collect and analyze data related to steering wheel dynamics, vehicle behavior, driver's driving characteristics, and driver load based on vehicle speed.

The output signals may be also associated with distinct locations relative to the steering wheel (e.g., at twelve o'clock, three o'clock, and so forth). In this manner, locations on the steering wheel may provide for additional user input variables, in addition to specific gestures. For example, a single tap at 12:00 relative to the steering wheel may be used to control the radio, with a single tap at 3:00 relative to the steering wheel being used to control the climate control. Thus, the same gesture may be used at different locations, resulting in different outputted control signals. The distinct locations may be defined by clock positions (also referred to as clock face positions). Thus, selection of location 12:00 as an input remains constant relative to the steering wheel, regardless of angular displacement of the steering wheel. The combination of gestures and locations allows for variability in mapping output signals useable as control signals.

The touch-detectable steering wheel element may be provided as a steering wheel cover that may be an aftermarket product installable on a steering wheel of any vehicle after manufacturing. Alternatively, the touch-detectable steering wheel may be incorporated into a steering wheel during initial manufacturing, thereby providing a new vehicle with the touch-detectable steering wheel element integrated into the steering wheel of the new vehicle. The touch-detectable steering wheel element will operate in similar manner whether installed as an aftermarket product or whether factory installed.

The following provides functionality of the touch-detectable steering wheel element. A plurality of zones may be utilized, each having its own wiring, to allow for independent sensing/operation of the zones for user touch detection. The zones may be also used for grip sensing based on the disclosure of U.S. Pat. No. 11,015,990.

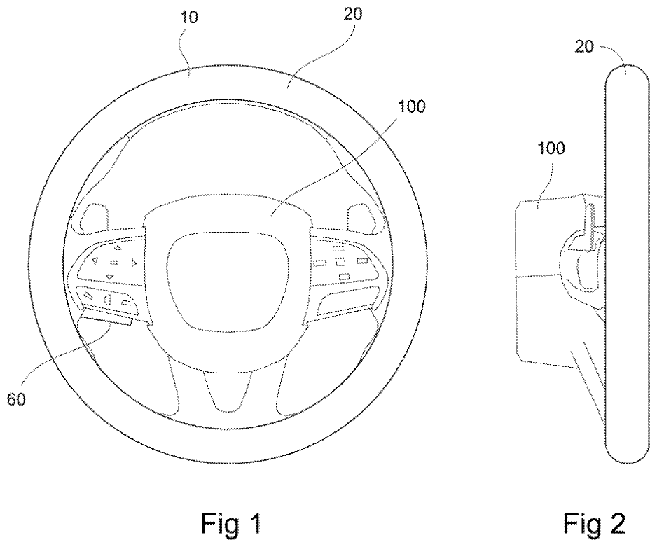

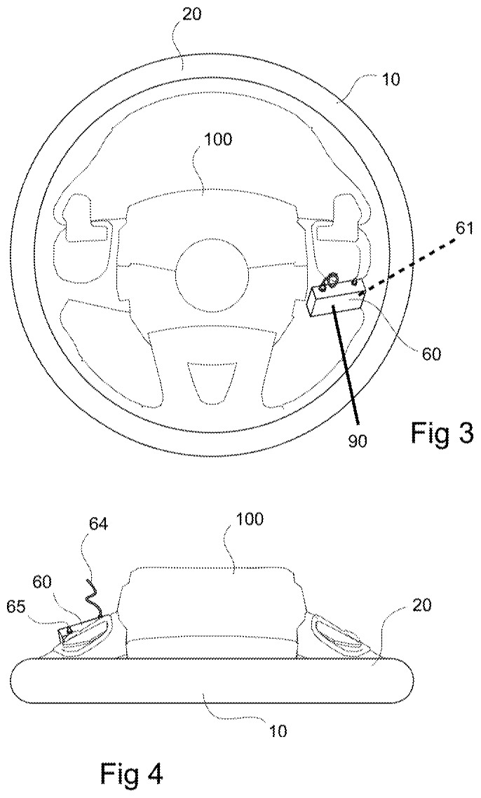

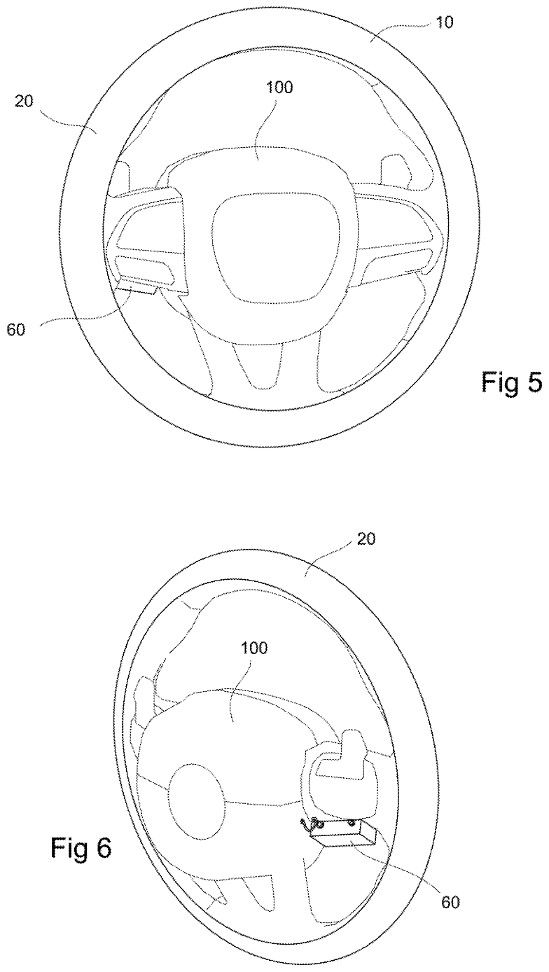

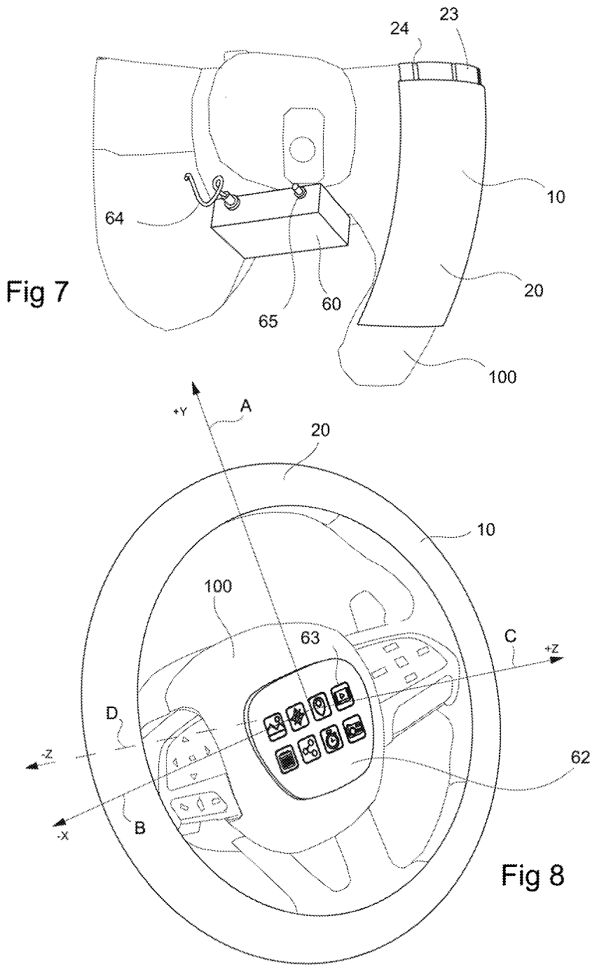

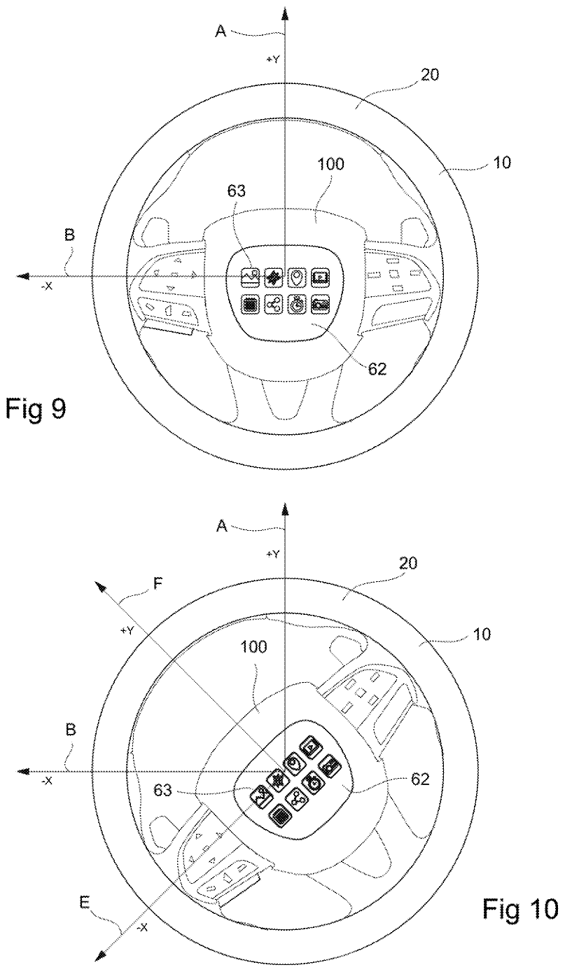

FIGS. 1-10 show different features of a steering wheel assembly including a touch-detectable steering wheel element 10 which is mountable to, or integrated with, an underlying functioning conventional steering wheel 100. The touch-detectable steering wheel element 10 and the steering wheel 100 together are taken to form a steering wheel assembly. As shown in the figures, the touch-detectable steering wheel element 10 is shown mounted to a steering wheel 100. The steering wheel 100 may be any known type of steering wheel, including being: a circular steering wheel (with one or more spokes); discontinuous with two or more handles; two handlebars, and so forth. The steering wheel 100 may be: round (formed about one radius or more than one radius); elliptical; rounded with flat portions; pilot-shaped; “butterfly-shaped”; irregular shaped; and so forth. The steering wheel 100, as is known in the art, may include controls (e.g., electronic controls for entertainment system, gear shifting, cruise control, etc.) and other features, such as a car horn, air bag, and so forth. The steering wheel 100 may be connected to a steering column which may also include controls and/or other features (e.g., ignition button or keyhole, turn signal handle, etc.).

The touch-detectable steering wheel element 10 includes an outer layer 20 that extends along at least a portion of an axial length of the steering wheel 100. The term “axial length” is used herein as the length of the steering wheel 100 which extends about (encircles) the axis of rotation of the steering wheel 100. For example, in connection with FIG. 1, the axis of rotation is generally perpendicular to the plane of FIG. 1, and the axial length lies generally in the plane of FIG. 1. Stated differently, axial length is defined along a grippable surface useable to engage with the steering wheel. For example, with the steering wheel configured as handlebars, the longitudinal length of each handlebar constitutes an axial length.

The outer layer 20 is shown in FIG. 1 as one continuous layer but may be provided to partially cover the axial length of the steering wheel 100 (i.e., cover less than the full axial length of the steering wheel 10) and/or to be provided to discontinuously cover the axial length of the steering wheel 100 (e.g., one or more separated outer layers 20 may be provided which extend over limited extents of the axial length of the steering wheel 100).

In addition, the outer layer 20 may be formed to extend about at least the majority of the circumference of the steering wheel 100 (i.e., to extend about at least 50% of the circumference of the steering wheel 100). The “circumference of the steering wheel 100” is the circumference of the steering wheel 100 as viewed in a direction along the axial length (i.e., the circumference of the steering wheel 100 is transverse to the axial length). Stated differently, the circumference of the steering wheel 100 is the circumference of the grippable surface useable to engage with the steering wheel. The circumference of the steering wheel 100 is generally transverse to the plane of FIG. 1.

Reference herein to “outer layer” is to one or more of the outer layers (in singular or plural) of the touch-detectable steering wheel element 10. With the touch-detectable steering wheel element 10 being an aftermarket cover, the outer layer 20 will be discontinuous along one or more portions of the circumference of the steering wheel 100, the discontinuity allowing for the mounting of the touch-detectable steering wheel element 10 to the steering wheel 100. The outer layer 20 may be discontinuous to also facilitate factory installation.

A plurality of axial strands 24 may be located beneath the outer layer 20 which extends along the axial length of the steering wheel 100. The axial strands 24 may be formed in accordance with U.S. Pat. No. 11,015,990. A plurality of circumferential sensors 30 may be also provided which are spaced apart along the axial length of the steering wheel 100 and which at least partially encircle the circumference of the steering wheel 10. The circumferential sensors 30 are disposed transversely to the axial strands 24. The circumferential sensors 30 are electrically conductive elements which may be formed similarly to the axial strands 24.

With the configuration of U.S. Pat. No. 11,015,990, capacitive sensing may be used by the subject invention to detect touch. As appreciated by those skilled in the art, any manner of electrical touch sensing may be utilized, including other capacitive sensing arrangements and/or any inductive sensing arrangements. For example, the axial strands 24 and/or the circumferential sensors 30 may be configured to detect induction, e.g., through the detection of changes in one or more generated magnetic field(s), as known in the art. With inductive touch sensing, it is preferred that the outer layer 20 be sufficiently deflectable to facilitate detection of detectable changes in generated magnetic field(s). Although less preferred, resistive touch arrangements may be utilized with the subject invention where the outer layer 20 would be sufficiently deflectable to allow inner conductive electric components to come into contact and create a circuit. Known resistive touch arrangements may be utilized. In addition, the sensing arrangement may be provided to be quiescent, entering an active sensing state upon detection of touch in an active zone of the touch-detectable steering wheel element 10 and/or detection of a control signal (e.g., a voice command, engagement of a physical switch, etc.).

The terms “touch” and “contact,” and derivatives thereof, are used interchangeably herein, intended to have the same meaning. As will be appreciated by those skilled in the art, the reference to “touch” or “contact” herein (and derivatives of the term “touch” and the term “contact”) covers physical contact as well as proximity sensing, where physical contact is not present, but the presence of a target (e.g., a finger) is sufficiently close to be detectable. Proximity sensing may be achieved by, but not limited to, inductive, capacitive, optical, magnetic, eddy-current, and, photocell technologies, as known in the art.

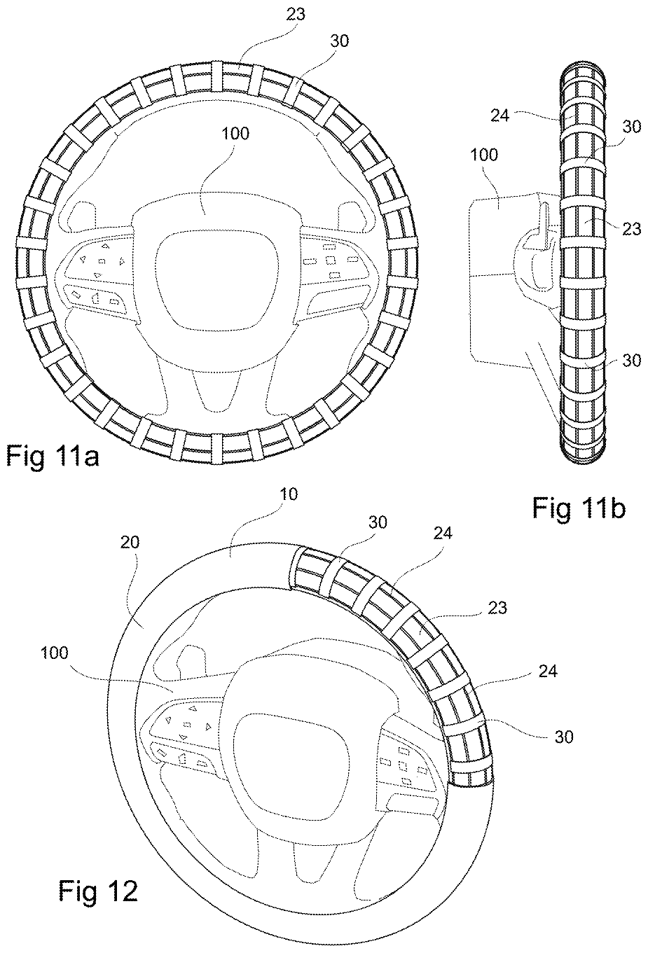

The outer layer 20, the axial strands 24, and the circumferential sensors 30 may be located atop a base layer 23 (FIGS. 11a, 11b, and 12), which is preferably non-conductive. With the touch-detectable steering wheel element 10 being integrated with the steering wheel 100, the base layer 23 may be a portion of the underlying steering wheel 100. Alternatively, where the touch-detectable steering wheel element 10 is a mountable cover (e.g., aftermarket cover), the base layer 23 may be a non-conductive layer formed to be compliantly mounted to the outer circumference of the steering wheel 100. The base layer 23 may be inherently elastic to allow for secure mounting to the steering wheel 100.

A central processor 60 is also provided which is electrically connected to the axial strands 24 and the circumferential sensors 30. Connections may be formed to create multiple independent sensing zones about the steering wheel 100. For example, the axial strands 24 may be provided in finite lengths to define zones Z along the axial length of the steering wheel 100. In this manner, the zones Z each cover a portion of the axial length of the steering wheel 100. This allows for separate and independent detection of touch between the zones Z. In addition, each of the circumferential sensors 30 may be separately connected to the central processor 60 to be separately detectable. Within each zone Z, the finite lengths of the axial strands 24 may be each separately detectable. The separate detection of the axial strands 24 and/or of the circumferential sensors 30 creates an unseen grid capable of detecting, and distinguishing, between different gestures of a user in contacting the touch-detectable steering wheel element 10.

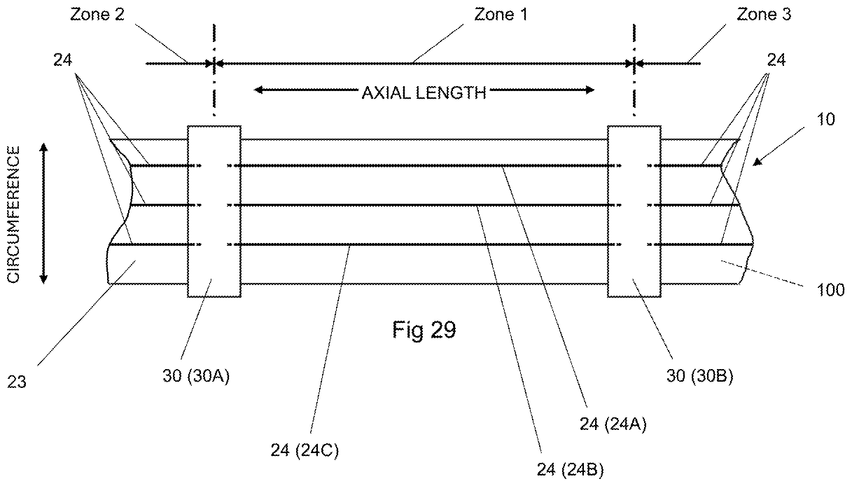

By way of non-limiting example, reference is made to FIG. 29 where different zones Z are shown distributed along the axial length of the steering wheel 100. The outer cover 20 is not shown in FIG. 29 for clarity. As shown in FIG. 29, the axial strands 24 may be foreshortened along the axial length of the steering wheel 100, such that distinct and spaced-apart axial strands in different zones Z may be end-to-end aligned along the axial length of the steering wheel 100. Each of the axial strands 24 may be connected to the central processor 60 allowing for touch detection at different locations along the axial length. For example, as shown in FIG. 29, a Zone 1 of the zones Z may be assigned to a group of axial strands 24 (24A, 24B, 24C, . . . ), located between a pair of adjacent circumferential sensors 30 (30A, 30B). The Zone 1 axial strands 24 are distinct and separate from the axial strands 24 of adjacent Zones 2 and 3 of the zones Z. This can be achieved by terminating the axial strands 24 of Zone 1 adjacent to, or underneath, the adjacent circumferential sensors 30A, 30B. With this arrangement, each of the axial strands 24 of Zone 1 and each of the adjacent circumferential sensors 30A, 30B is independently capable of detecting touch by a user. The remainder of the touch-detectable steering wheel element 10 may be formed with further similar zones Z, such as Zones 2, 3, . . . . In addition, zones Z may be provided for no detection. This allows for the steering wheel 100 to have areas of no contact detection to minimize signal confusion. As appreciated by those skilled in the art, points of contact between the axial strands 24 and the circumferential sensors 30 may be insulated to prevent electrical shorts and improper readings. Preferably, the zones Z are provided to be in end-to-end succession to cover the full axial length of the steering wheel 100. In other words, every portion of the axial length of the steering wheel 100 is preferably associated with a zone Z.

A user may utilize the following hand/finger gestures in connection with the subject invention:
1. Single finger contact
2. Two finger contact
3. Single finger tapping (intermittent contact)
4. Two finger tapping (intermittent contact)
5. Grasping
6. Swiping (moving contact)
7. Two finger magnification
8. Two finger contraction
   Other gestures, distinct from those listed, may be likewise utilized, such as based on hand and/or palm gestures (e.g., area contact, gripping, squeezing, and so forth). These gestures may be mapped to act as different control inputs. Specifically, the central processor 60, using the hand/finger/palm gestures as inputs, may output corresponding control signals which are transmitted to the vehicle, elements within the vehicle, and/or outside devices. The central processor 60 may be hardwired or wirelessly connected to the vehicle or other accessory, as will be appreciated by those skilled in the art, to transmit control signals.

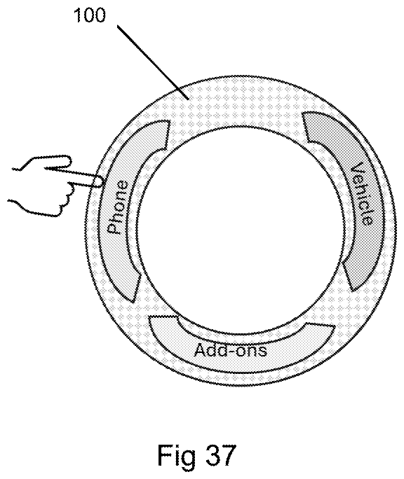

With typical touch inputs, such as touch screens, a user's focus is on icons or other graphical user interface(s) (GUI's) provided on the respective screen which intuitively show the user where to engage the screen. With a steering wheel in use during driving, a driver's focus is on the road. Thus, a driver's ability to locate a specific location on a steering wheel to engage or touch during driving is limited. The subject invention allows for touch detection along the axial length and the circumference of the steering wheel at predefined fixed locations without need for precise touch locations. To assist a driver, regions of the steering wheel 100 may be designated for certain actions. For example, as shown in FIG. 37, three o'clock (+/−additional time) on the steering wheel 100 may be designated for vehicle control (e.g., entertainment system, windshield wipers, etc.) with separate region(s) controlling other elements (e.g., six o'clock (+/−additional time), nine o'clock (+/−additional time), and so forth). This allows for designated areas for particular controls, independent of the rotational position of the steering wheel 100. Each of the regions may be coextensive with one zone Z, or, alternatively, where a larger target region is preferred, one or more of the region(s) may be associated with two or more of the zones Z. The length of the zones Z may be also adjusted to define desired target areas.

Touch locations may be combined with gestures to provide numerous combinations for user inputs for various controls. For example, single finger contact (single finger tap) may be detected at various distinct locations about the steering wheel (twelve o'clock, six o'clock, and so forth) to generate different output signals.

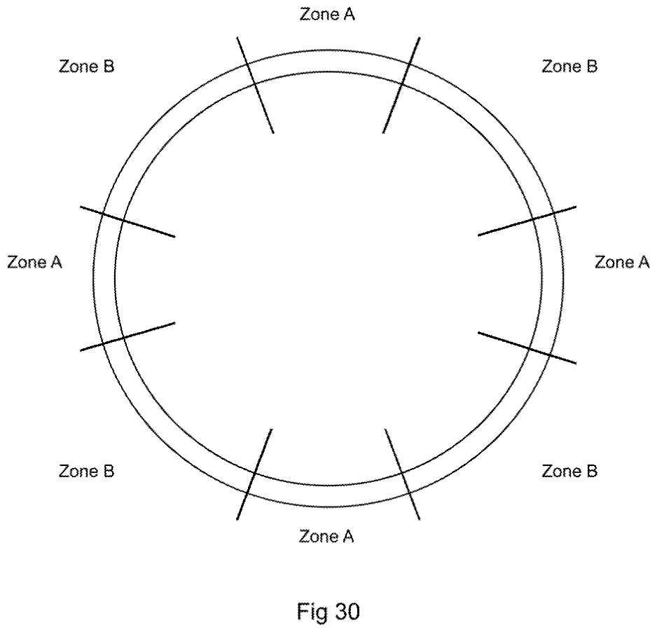

In addition, the touch-detectable steering wheel element 10 may be provided with regions of no touch detection. For example, as shown in FIG. 30, the zones Z of the touch-detectable steering wheel element 10 may be divided into active and inactive zones. Active zones may be defined across limited arcs at three o'clock, six o'clock, nine o'clock, and twelve o'clock positions, as designated by Zones A. These positions are generally out of alignment with a driver's hands during normal driving operation. The Zones A may each extend across an arc allowing for a length of area to engage. The zones in between (Zones B) may provide inactive arcs for a driver's hands. For example, Zones B may be located to coincide with ten o'clock and two o'clock positions which are commonly associated with hand positions for driving. As will be appreciated by those skilled in the art, Zones A and B may be differently configured, e.g., with use of less Zones A. In addition, one or more lines of demarcation may be provided on the outer layer 20 to visually show the location of Zones A and B, i.e., to delineate active and inactive zones.

The Zones A may be each configured in the same manner as Zone 1 described above. In addition, Zone A may internally include two or more consecutive active zones. This allows for intra- and inter-zonal detection (i.e., within a zone and between zones). It is noted that the Zones B may be each configured for grip sensing (sensing extent of grip) in accordance with U.S. Pat. No. 11,015,990. This allows for varying (e.g., alternating) active touch-sensitive and grip-sensing zones.

The references to Zone 1, Zone 2, Zone 3, Zones A, and Zones B herein are for illustrative purposes. All of these zones are part of the general category of the zones Z. Any of the zones Z may be formed in accordance with the any of Zone 1, Zone 2, Zone 3, Zones A and/or Zones B.

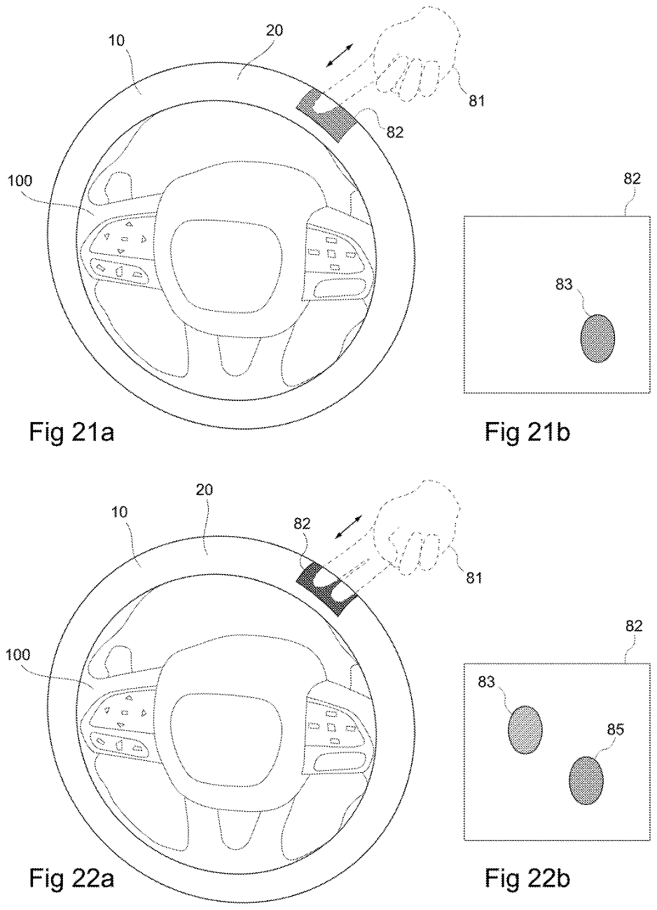

FIGS. 18a and 18b show a user's hand 81 engaging the touch-detectable steering wheel element 10 with one-finger touch (i.e., pressing contact) in an engagement area 82 on the outer cover 20. Profile 83 in FIG. 18b shows schematically the area of touch on the outer cover 20. The profile 83 will overlay one or more of the axial strands 24 and/or the circumferential sensors 30. Detection by one of these elements provides an indication of single finger contact. With reference to FIGS. 21a and 21b, with movement of the user's finger, in and out of contact with the outer surface 20, a tapping motion is created. The same profile 83 may be defined by intermittent single finger contact. The central processor 60 is preferably configured to collect readings over time. This allows for evaluation of whether an intermittent single point contact is present, indicative of a single finger tapping. The central processor 60 may be provided with minimum timing thresholds to evaluate contact or tapping. For example, a minimum length of time of contact may be required to determine whether a contact (e.g., single contact) is present. This protects against inadvertent contact, e.g., where a user's hand slides across an active touch zone Z (e.g., a Zone A) while driving. In addition, minimum lengths of time of non-contact and contact may be used to identify single finger tapping (e.g., minimum lengths of time of contact separated by minimum length of time of non-contact).

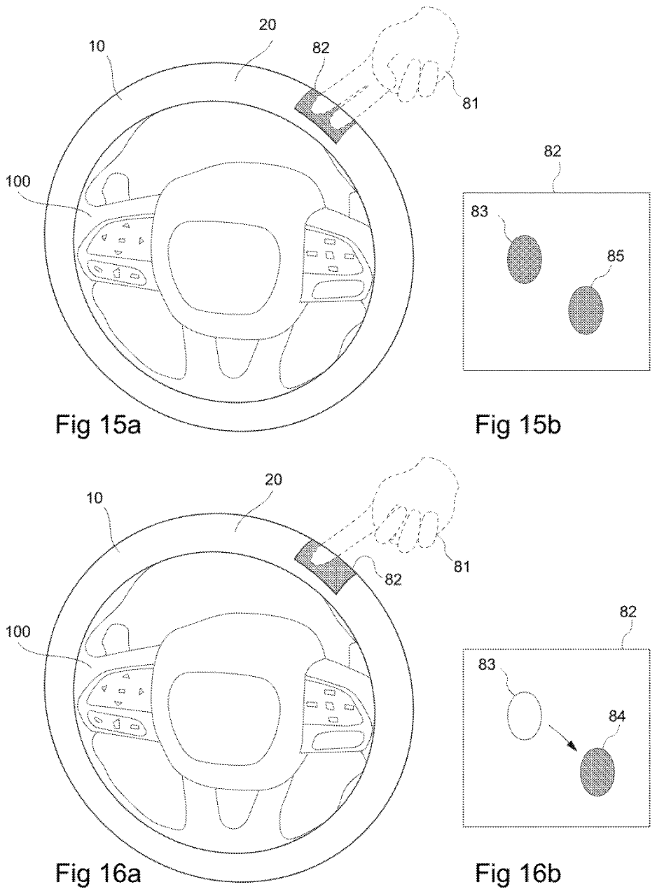

FIGS. 15a-15b show a user's hand engaging the touch-detectable steering wheel element 10 with multi-finger contact in an engagement area 82 on the outer cover 20. For example, two finger contact may be detected by simultaneous detection by two or more of the axial strands 24 and/or the circumferential sensors 30. The multi-finger detection may be within the same zone Z (e.g., between two or more different axial strands 24) or between different zones Z. In the same manner as described above, the multi-finger contact may be detected by minimal length of contact. As shown in FIGS. 22a-22b, intermittent contact may be also detected in identifying multi-finger tapping.

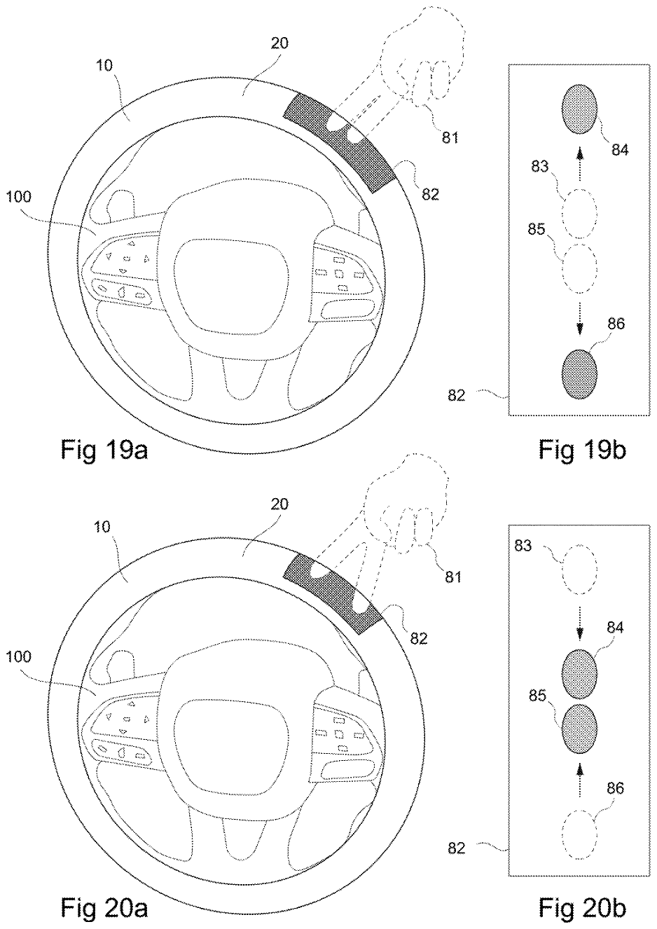

As further shown in FIGS. 19a-20b, two finger contact may utilize movement between the fingers to provide additional inputs. As shown in FIGS. 19a-19b, the fingers may initially have positions as shown by profiles 84, 86 with subsequent inward movement to positions shown by profiles 83, 85. This action may be taken as a control input for contraction or lessening (e.g., volume reduction). FIGS. 20a-20b show the opposite action where the fingers move outward from initial positions shown by profiles 84, 85 to positions shown by profiles 83, 86. This action may be taken as a control input for magnification or making greater (e.g., increasing volume). With both of these actions, displacement of the fingers is required. Detection across multiple elements (one or more of the axial strands 24 and/or the circumferential sensors 30) may be used to identify movement, particularly with sequential detection.

FIGS. 16a-16b show a swiping action. As discussed above, multiple elements (one or more of the axial strands 24 and/or the circumferential sensors 30) may be used to identify movement, particularly with sequential detection. FIGS. 16a-16b show a single finger, but two or more fingers may be used to swipe.

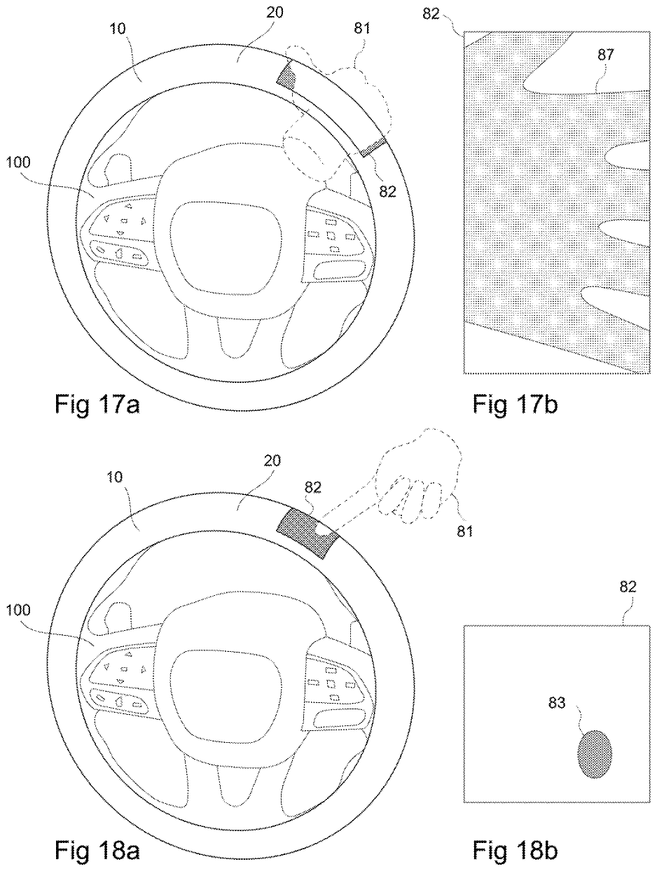

FIGS. 17a-17b show a user's hand or palm 81 grasping an area. Area contact of grasping, particularly in an active zone Z (e.g., Zone A), may be detected with simultaneous contact of multiple elements (one or more of the axial strands 24 and/or the circumferential sensors 30), particularly with simultaneous contact across a plurality of axial strands 24 disposed about the circumference of the steering wheel 100. This is similar processing to grip sensing described in U.S. Pat. No. 11,015,990. Grasping may be detected within an active zone or between zones.

As will be appreciated by those skilled in the art, the subject invention preferably avoids input confusion, for example, being able to distinguish between contact of the steering wheel 100 during normal driving and intentional contact for input. One approach to avoid signal confusion is described above with inactive zones (Zones B) being arranged for a driver's hands and, in parallel, active zones (Zones A) for accepting user inputs. In addition, or alternatively, inputs may be provided for “awakening” the system (e.g., the central processor 60) from a quiescent state to a ready, active state. For example, a microphone 65 (e.g., provided with, or operatively linked to, the central processor 60) may be provided as an additional input. Voice commands may provide additional control inputs in addition to touch commands. Voice commands may be also utilized to “awaken” the system from a quiescent state to a ready, active state. Standard voice-recognition software may be utilized. An external microphone, such as one equipped with the associated vehicle, may be utilized as well, with the external microphone being communicatively linked to the central processor 60 to pass signals thereto based on received voice commands. In addition, or alternatively, external switch(es), application software on an external device, graphical user interface(s) (GUI(s)) 62 (e.g, provided on the steering wheel 100 with interactive icons 63), and/or other user interfaces may be used which act to provide input(s) to the central processor 60 and/or which allow for “awakening” the system from a quiescent state to a ready, active state. Additionally, the system may enter a quiescent state, where user inputs are not detected with passage of a predetermined period of inactivity, and/or using any of the aforementioned input(s) to provide an “off” command or the like to have the system enter the quiescent state. Further, in addition, or alternatively, any of the aforementioned input(s) may be used to adjust working states of the system. For example, the system may be provided with a fully functional state, where gestures are detected with zonal reassignment. A partially functional state may be provided where gestures are detected, but without zonal reassignment. The input(s) may be used to toggle or adjust the state of the system from “off” (quiescent) to fully “on” (active) with one or more partially active states therebetween offering partial functionality.

The subject invention may be used in connection with multi-hand inputs where a user contacts separate zones Z, simultaneously and/or in succession, to provide two or more touch inputs. This allows for additional input possibilities. The inputs may be simultaneous and/or sequential, with the central processor 60 configured to detect contact(s), including at different locations, over a duration of time to allow for sequential touch detection. As appreciated by those skilled in the art, sequential detection may be used also in connection with single-handed inputs, allowing for a series of gestures to be mapped to an output signal.

The central processor 60 may be configured to detect a particular input or inputs and correlate the input(s) to one or more output signal(s), which is/are transmitted by the central processor 60. The central processor 60 may include a wireless transmitter to transmit generated output signals. In addition, or alternatively, the central processor 60 may be hardwired to the vehicle or other accessory to transmit output signals (e.g., USB cable) in digital or analog form. In this manner, specific touches of the touch-detectable steering wheel element 10 are converted to output signals.

The central processor 60 may be attached to the rear of the touch-detectable steering wheel element 10, particularly where the touch-detectable steering wheel element 10 is an aftermarket cover. The central processor 60 may be integrated with other electronics of the vehicle where the touch-detectable steering wheel element 10 is integrated with the steering wheel 100. Power may be provided by battery, charging source (induction charging, charge cable) or supplied (wired transmitter for transmitting output signals and/or wireless) from the vehicle or an accessory. The central processor 60 includes a computer processing unit (CPU) with memory, having stored therein computer instructions, to carry out the process(es) described herein. The central processor 60 may include a transmitter (wired or wireless) for transmitting output signals and/or a receiver (e.g., wireless receiver or transceiver) to receive software or firmware updates.

Preferably, the central processor 60, particularly the CPU, is operatively linked to the associated vehicle to receive inputs therefrom, such as indication of start-up of the vehicle. This input may be used to “awaken” the central processor 60 from a quiescent state. Likewise, a signal may be provided to the central processor 60 indicating shut down of the vehicle with this signal causing the central processor 60 to enter the quiescent state.

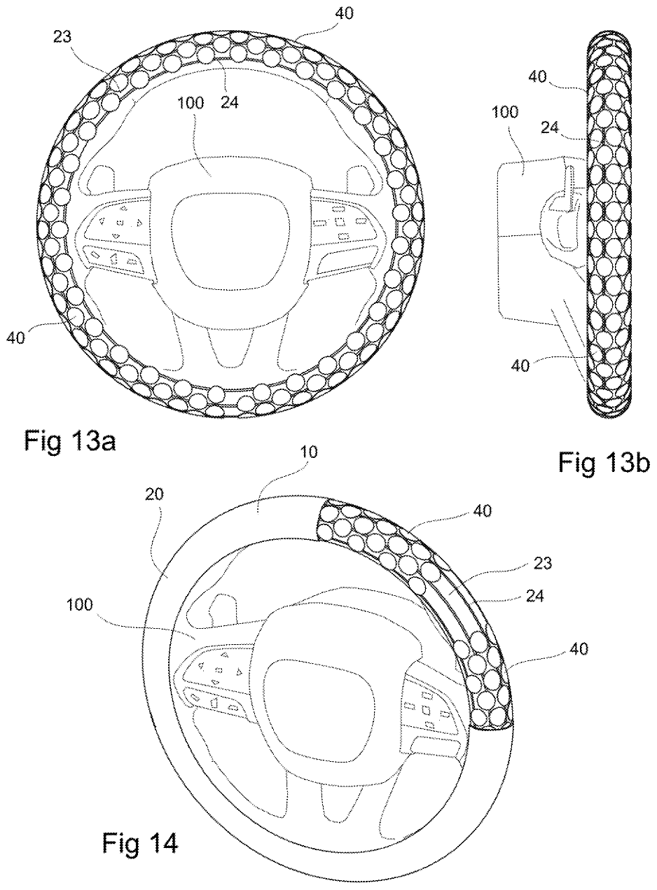

Other configurations of touch sensors may be used in conjunction with, or alternatively, to that described above in connection with the subject invention. By way of non-limiting example, as shown in FIGS. 13a-14, a plurality of disc-shaped sensors 40 may be utilized which are evenly distributed both along the axial length, and the circumference, of the steering wheel 100. The disc-shaped sensors 40 are preferably sized to each have a diameter smaller than the length of the circumference of the steering wheel 100. In this manner, a plurality of the disc-shaped sensors 40 are needed to extend across the circumference of the steering wheel 100. Similarly, the diameter of the disc-shaped sensors 40 are preferably much smaller than the axial length of the steering wheel 100. This allows for a level of granularity in detecting touch both along the circumference and the axial length of the steering wheel 100.

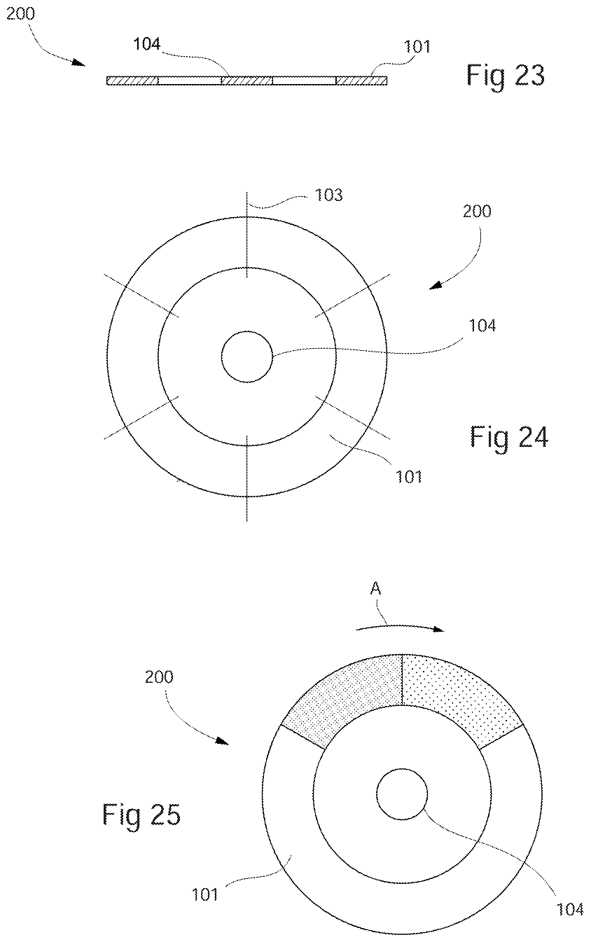

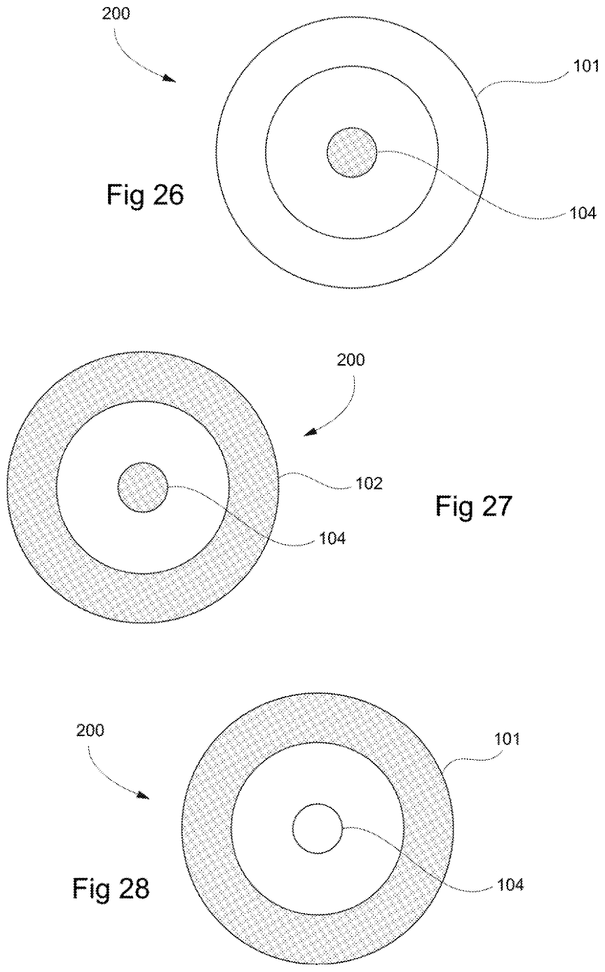

As a further alternative, FIGS. 23-28 show an active zone sensor 200 for touch detection comprised of an inner solid disc 104 encircled by an annular ring 101. An annular gap is located between the disc 104 and the ring 101 giving the sensor 200 an overall appearance of a bullseye. The disc 104 and the ring 101 are both conductive sensors securable to the outer cover 20. As shown in FIGS. 26-28, contact with the disc 104 and the ring 101 provides for separate detectable inputs, with simultaneous contact with the disc 104 and the ring 101, e.g., with two fingers, providing a further input. Transverse sensors 103 may be provided about the ring 101. These can be configured to detect sliding contact along the ring 101. In this manner, swiping movement along the ring 101 may be detected, allowing for clockwise and counterclockwise movements providing for additional inputs. The active zone sensors 200 may be arranged both along the axial length, and the circumference, of the steering wheel 100 in similar fashion to the disc-shaped sensors 40.

Any touch-sensor arrangement which allows for gesture detection and detection of the location of applied gestures is useable with the subject invention.

The outer cover 20 should be formed to allow for detection of contact, e.g., changes in capacitance, by the axial strands 24 and/or circumferential sensors 30 in response to contact with the outside of the outer cover 20. The outer cover 20 may be varied by material and/or thickness of the material to facilitate proper contact detection. In addition, it is noted that many people drive with gloved hands. Gloves may interfere with the operation of the subject invention.

The subject invention utilizes a detector 61 for detecting angular displacement of the steering wheel 100 during use. The detector 61 may be in the form of an inertial measurement unit (IMU) but may be any configuration which continuously detects angular displacement of the steering wheel 100. The detector 61 is coupled (directly or indirectly) with the central processor 60 to provide output thereto. In this manner, the angular displacement of the steering wheel 100 is continuously monitored. The angular displacement of the steering wheel 100 may be determined based on relative changes of angular positioning of the steering wheel 100 (i.e., incremental changes from moment to moment) and/or changes in angular positioning of the steering wheel 100 as compared to an absolute position (i.e., determining current position relative to a fixed position). A housing 90 may be provided for enclosing the central processor 60 and the detector 61, particularly where the touch-detectable steering wheel element 10 is an after market product. With factory installation, the detector 61 may be built into the steering wheel 100, or the column thereof, separated from the central processor 60 but in communication therewith.

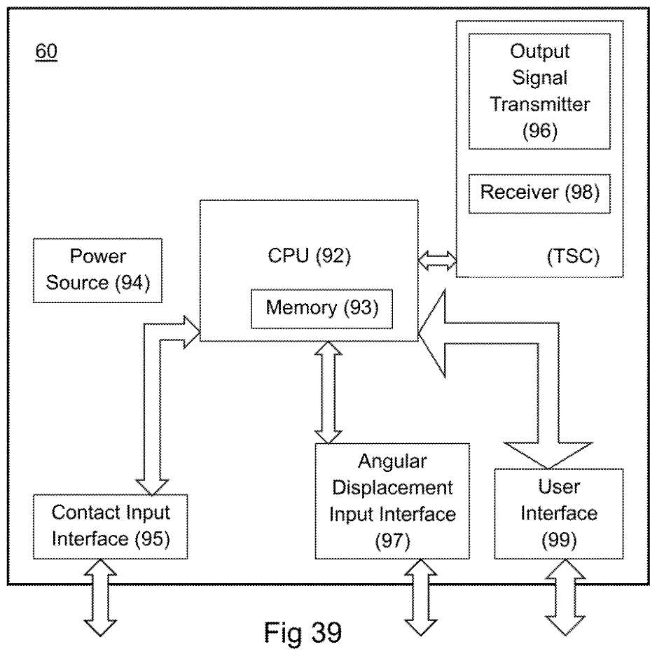

FIG. 39 is a schematic of the central processor 60 having a CPU 92, memory 93 associated with the CPU, power source 94, contact input interface 95, output signal transmitter 96, angular displacement input interface 97, user interface 98, and, optionally, a receiver 99. The contact input interface 95 is configured to receive signals based on contact detected by the touch-detector sensor arrangement. The angular displacement input interface 97 is configured to receive signals representing angular displacement of the steering wheel 100. The user interface 98 is configured to interface with any user commands or inputs, however communicated. The interfaces 95, 97, 98 may be of any form configured to receive data-encoded signals, such as wireless or wired interfaces. It is noted the transmitter 96 and/or receiver 99 may be configured to any standard (e.g., radiofrequency (RF), IEEE 802.15-compliant) permitting wireless communication with external elements (e.g., RF, Bluetooth, Zigbee, SNAP and so forth), including communicating with a device having application software for interfacing with the central processor 60. The transmitter 96 may be combined with the receiver 99 to be provided as a combined transceiver TSC.

The central processor 60 may have any interface which allows for a user to input settings or other selections. For example, a user may map desired contact gestures with output signals at particular locations about the steering wheel 100 to achieve desired intended effects. Application software may be used to communicatively link the central processor 60 with a user's smartphone or other device with the smartphone or device providing the user with a graphical user interface (GUI) to accept input from the user. In addition, or alternatively, the housing 90 may be provided with one or more interfaces (touch screen, keyboard, track pad, and so forth) to accept user input. The central processor 60 may be coupled using a cable 64 (e.g. a USB cable), shown representatively in FIG. 4. It is noted that a library may be stored in the memory 93 having preset associations of contact gestures with output signals at particular locations about the steering wheel 100. The library may be made available to the user, e.g., through the application software or other interface, to allow the user to make and save changes to the preset associations. Further, the application software may be used to turn the system on or off, i.e., put the central processor in and out of an active, ready state. The application software may be also used to selectively turn on or off features, thereby allowing partial functionality (e.g., contact gesture detection without zonal reassignment).

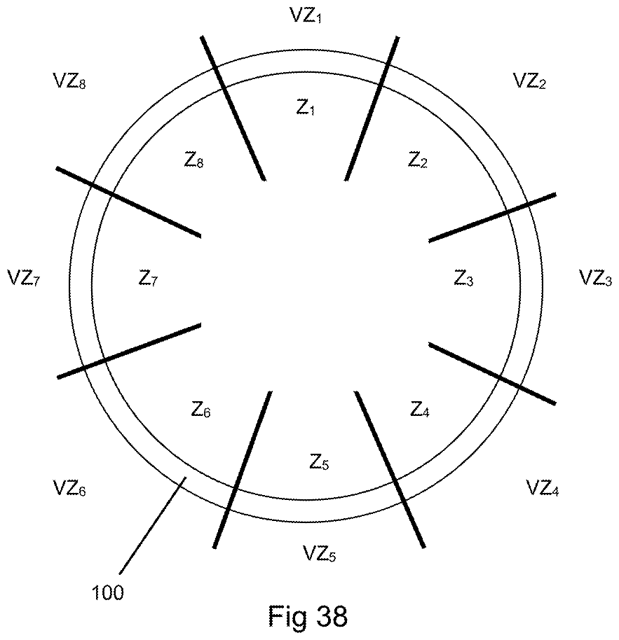

As shown in FIG. 38, the steering wheel 100 is rotatable. To characterize the extent of angular displacement of the steering wheel 100, a series of stationary virtual zones VZ (VZ₁, VZ₂, . . . ) is shown encircling the steering wheel 100. The stationary virtual zones VZ are for reference and do not move. The steering wheel 100 is angularly displaced relative to the stationary virtual zones VZ. The stationary virtual zones VZ may be provided in various quantities, the quantity being a function of the lengths of the stationary virtual zones VZ. Preferably, the stationary virtual zones VZ are of equal length. In addition, for illustrative purposes, it is preferred that a first stationary virtual zone VZ (e.g., VZ₁) is provided and configured to overlap the 12:00 position. In this manner, the 12:00 position is overlapped by the first stationary virtual zone VZ₁. Furthermore, it is preferred that the first stationary virtual zone VZ₁ extend circumferentially from the 12:00 position in both directions (clockwise and counterclockwise). This provides a larger target area about the 12:00 position for contact by a user. Precise locating of a contact point is thus not required. By way of non-limiting example, the first stationary virtual zone VZ₁ may extend from 11:15 to 12:45 positions about the steering wheel 100, thus overlapping the 12:00 position with +/−45 minutes extra. It is further preferred that at least one or more of the 3:00, 6:00, and/or 9:00 positions be overlapped by stationary virtual zones VZ. It is noted that for an active driver, the 12:00 position relative to the steering wheel 100 may be the easiest position to identify since this position is in, or closest, to the driver's line of sight while actively driving. It is also taken that an active driver may readily identify 3:00, 6:00, and 9:00 positions relative to the steering wheel 100 while actively driving, using general cardinal directions (north, east, west, south) relative to the 12:00 position for identification.

As shown in FIG. 38, eight, equal-length, stationary virtual zones VZ (VZ₁-VZ₈) may be used with the subject invention to encircle the steering wheel 100 for reference. It is preferred that the quantity and length of the stationary virtual zones VZ match that of the zones Z (Z₁-Z₈), including active and inactive zones (Zones A and B). With this arrangement, the stationary virtual zones VZ may be fully radially aligned with the zones Z, as shown in FIG. 38, in a reference position. Angular displacement of the steering wheel 100 from the reference position shown in FIG. 38 will misalign the stationary virtual zones VZ and the zones Z. The detector 61 is used to monitor the extent of misalignment between the stationary virtual zones VZ and the zones Z.

By way of non-limiting example, and as shown in FIG. 38, the stationary virtual zones VZ, where a quantity of eight are utilized, may be defined by the following start and end points using clock face references:

| Stationary Virtual Zone | Start Point | End Point |
|---|---|---|
| 1 | 11:15 | 12:45 |
| 2 | 12:45 | 2:15 |
| 3 | 2:15 | 3:45 |
| 4 | 3:45 | 5:15 |
| 5 | 5:15 | 6:45 |
| 6 | 6:45 | 8:15 |
| 7 | 8:15 | 9:45 |
| 8 | 9:45 | 11:15 |

The start and end points are expressed in a clockwise direction but may be equally expressed in a counterclockwise direction. As will be appreciated by those skilled in the art, other quantities, lengths, and/or angular positions (different clock positions) of the stationary virtual zones VZ may be used. Again, conformance between the stationary virtual zones VZ and the zones Z is preferred.

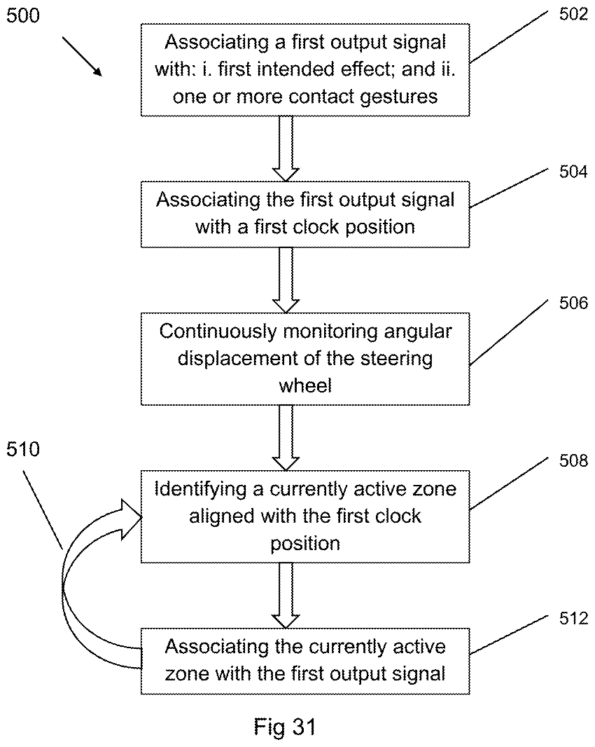

FIG. 31 shows a method 500 which is useable to accept user inputs on a steering wheel assembly during use in accordance with the subject invention, with the steering wheel assembly including the touch-detectable steering wheel element 10 mounted on, or integrated with, the steering wheel 100. The method 500 includes a first step 502 of associating a first output signal with i. a first intended effect and ii. one or more contact gestures. In this manner, a first output signal is mapped to an intended effect which may be one or more of: control over one or more vehicle features (e.g., vehicle entertainment system, navigation system, etc.); control over one or more vehicle displays (e.g, overhead display, dashboard display, etc.); control over one or more vehicle elements (e.g., climate control, windshield wipers, interior lighting, headlights, cruise control, etc.); and, control over communication with third parties (e.g., cellular communication, texting, VOIP calling, distress signaling, etc.). The first output signal is also mapped to one or more contact gestures which may be selected from: single finger contact, multi-finger contact, single finger tapping, multi-finger tapping, grasping, swiping, two finger magnification, two finger contraction, hand gestures, and palm gestures.

The method 500 further includes a second step 504 of associating the first output signal with a first clock position relative to the steering wheel. In this manner, a fixed position relative to the steering wheel 100 is selected for user input. For example, the first clock position may be 12:00 where the location for user input is the topmost portion of the steering wheel 100.

In a third step 506 of the method 500, angular displacement of the steering wheel 100 is continuously monitored during use. The detector 61 may be used to continuously monitor the angular displacement of the steering wheel 100. This allows for identifying the rotational position of the steering wheel 100 at a given moment.

With a fourth step 508 of the method 500, a currently active zone of the touch-detectable steering wheel element 10 is identified, based on the angular displacement of the steering wheel 100, which is, at a given moment, in alignment with the first clock position. The monitored angular displacement of the third step 506 is used to identify the zone of the touch-detectable steering wheel element 10, at the given moment, in alignment with the first clock position. As represented by process arrow 510, the fourth step 508 is iteratively performed to continuously identify the currently active zone of the touch-detectable steering wheel element 10.

In a fifth step 512 of the method 500, upon being identified, the currently active zone is associated with the first output signal such that application of the one or more contact gestures by the user within the currently active zone is translatable into generation of the first output signal. This allows for continuous updating of the zone of the touch-detectable steering wheel element 10 being aligned with the first clock position and making that zone be active for receiving the one or more contact gestures associated with the first output signal to cause generation of the first output signal. Advantageously, in use, the location for contact input relative to the steering wheel 100 remains constant, but, in fact, may vary along the axial length of the steering wheel 100. The first output signal, once generated, may be transmitted to the target feature or element to carry out the first intended effect.

As appreciated by those skilled in the art, the method 500 may be performed in parallel to associate multiple output signals with intended effects to allow for control over various features and elements. For example, in accordance with the processing as in the first step 502, but separate therefrom, a second output signal may be associated with a second intended effect and one or more secondary output gestures. The second output signal may be associated with a second clock position relative to the steering wheel 100 (same processing as in the second step 504). A second currently active zone is identified, based on the angular displacement of the steering wheel 100, which is, at a given moment, in alignment with the second clock position (same processing as in the fourth step 508). Upon being identified, the second currently active zone is associated with the second output signal such that application of the one or more secondary contact gestures by the user within the second currently active zone is translatable into generation of the second output signal (same processing as the fifth step 512). In similar fashion to that described above, and represented by the process arrow 510, the second currently active zone is identified and associated with the second output signal iteratively. Additional output signals may be further processed in parallel. It is understood that the second clock position may be distinct from the first clock position and that the second intended effect may be distinct from the first intended effect.

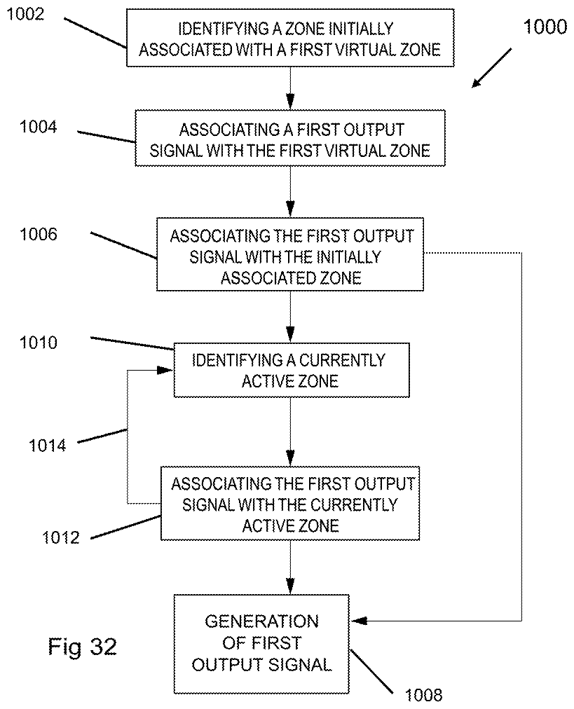

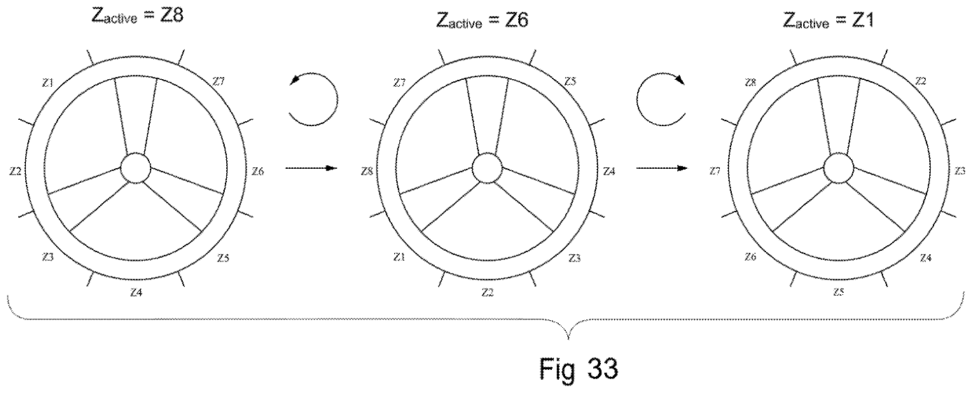

FIG. 32 shows a method 1000 which is also useable with the touch-detectable steering wheel element 10. The method 1000 allows for zonal assignments of output signals and zonal reassignment of those output signals based on rotational displacement of the steering wheel 100. The method 1000 is performable by the central processor 60. The method 1000 may start with a driver seeking to initiate a session of use of the steering wheel 100 equipped with the touch-detectable steering wheel element 10. This may involve a driver entering a vehicle having the steering wheel 100 equipped with the touch-detectable steering wheel element 10. With activating the vehicle (starting the vehicle), the session of use of the steering wheel 100 may be considered initiated. As discussed above, the start-up of the vehicle may cause an input to be transmitted to the central processor 60 to enter an active, ready state. As set forth in a first step 1002 of the method 1000, at initiation of the session of use of the steering wheel 100, a zone from the zones Z may be identified as being initially associated with a first selected virtual zone VZ. The first selected virtual zone VZ is predetermined to define a target zone for accepting contact to control a particular feature, element, and so forth of the associated vehicle. For example, the first selected virtual zone VZ may be predetermined to be the stationary virtual zone VZ overlapping the 12:00 position. This predetermination sets the 12:00 position as a target position on the steering wheel 100 to control the particular feature or element. Other clock face positions may be utilized.

The first step 1002 identifies the initially-associated zone Z by one of at least two processes. In one process, the initially-associated zone Z is identified as the zone of the zones Z which is aligned with the first selected virtual zone VZ at the initiation of the session use. Thus, with the stationary virtual zone VZ overlapping the 12:00 position, the initially-associated zone Z may be taken as the zone of the zones Z which is radially aligned with the 12:00 position. Alternatively, in a second process, the initially-associated zone Z may be identified based on a predefined default setting. For example, a particular zone Z is identified as the initially-associated zone Z without consideration of radial alignment with any of the stationary virtual zones VZ. It is understood that the steering wheel 100 may be left in any rotational position after a driving session. With start-up of the vehicle, the second process may identify the zone Z at a particular clock face location without the need to determine radial alignment. This is effective where the predefined default setting is beforehand set to the same clock position as the first selected virtual zone VZ providing de facto radial alignment.

In a second step 1004, a first output signal is associated with the first selected virtual zone VZ. This may be done prior to the first step 1002 or initiation of the session of use. This association may be stored in the memory of the CPU of the central processor 60. The association of the first output signal with the first selected virtual zone VZ may include two elements: i. selection of one or more contact gestures; and, ii. the intended effect of the first output signal. For example, the intended effect of the first output signal may be volume control on the vehicle's entertainment system. Two finger magnification and contraction, as described above, may be selected as the one or more contact gestures for volume increase and volume decrease, respectively. Of course, other combinations are possible. As will be appreciated by those skilled in the art, multiple output signals may be associated with the first selected virtual zone VZ in similar fashion. Accordingly, multiple contact gestures may be associated with the first selected virtual zone VZ with resulting different intended effects. The selection of the one or more contact gestures may be considered to define contact in a predetermined manner.

In a third step 1006 of the method 1000, the initially-associated zone Z identified in the first step 1002 is associated with the first output signal of the second step 1004. In this manner, as set forth in fourth step 1008, a user applying the one or more selected contact gestures to the initially-associated zone Z results in generation of the first output signal by the central processor 60, the first output signal encoded to carry out the intended effect. It is understood that a user may choose to not carry out the intended effect, thus not applying the one or more selected contact gestures. The third step 1006 is based on the identification of the initially-associated zone Z, which should be in radial alignment with the first selected virtual zone VZ. The third step 1006 is based on little to no relative rotation between the initially-associated zone Z and the first selected virtual zone VZ. As discussed further, angular displacement of the steering wheel 100 may cause reassignment (re-association) of the first output signal from the initially-associated zone Z to a different zone Z.

Once generated, the first output signal is transmitted by the central processor 60 to a target feature or element where the first output signal is processed and used to carry out the intended effect. Thus, following the example given above, and assuming there has been little to no relative rotation between the initially-associated zone Z and the first selected virtual zone VZ, the applying of two finger magnification or contraction by the driver on the initially-associated zone Z, which coincides with the 12:00 position, or thereabout, results in the first output signal being generated and transmitted to increase/decrease the volume of the vehicle's entertainment system. This intended effect is not achievable with application of a different contact gesture and/or application of the contact gesture outside of the 12:00 position, including its extended length.

The method 1000 continuously monitors angular displacement of the steering wheel 100 during the session of use. As discussed above, the detector 61 detects angular displacement of the steering wheel 100. The detector 61 transmits output regarding the angular displacement of the steering wheel 100 to the central processor 60. As set forth in the fifth step 1010 of the method 1000, during the session of use of the steering wheel 100, based on the angular displacement of the steering wheel 100, the central processor 60 identifies a currently active zone, the currently active zone being identified as the zone from the zones Z aligned, at the moment, with the first selected virtual zone VZ. As set forth in sixth step 1012 of the method 1000, upon the currently active zone being identified, the currently active zone is associated with the first output signal, to the exclusion of the other zones, including the initially-associated zone Z, such that contact by the user of the currently active zone in the predetermined manner is translatable into generation of the first output signal (fourth step 1008).

As mentioned above, and shown by process arrow 1014, the fifth step 1010 is conducted iteratively to continuously identify the currently active zone and associate the identified currently active zone with the first output signal (sixth step 1012). In this manner, the method 1000 continuously associates the zone of the zones Z of the touch-detectable steering wheel element 10 which is radially aligned with the first selected virtual zone VZ. This allows for a fixed-position input location relative to the steering wheel 100 regardless of angular displacement. Thus, further to the example above, the volume control will continuously be at the 12:00 position for a user regardless of the angular displacement of the steering wheel 100. The fifth step 1010 may be iteratively repeated every 0.01 seconds to 10 seconds to ensure up-to-moment identification of the currently active zone.

As will be appreciated by those skilled in the art, one or more output signals may be associated with one or more of the stationary virtual zones VZ. This allows for fixed-position control input at multiple locations relative to the steering wheel 100. For example, in parallel to the 12:00 position associated with the first output signal, a second position, such as a 3:00 position, may be associated with a second output signal. This also allows for separation, and grouping, of control commands. For example, entertainment controls (on/off, channel selection, volume control . . . ) may be associated with one clock position (e.g., 12:00) with car-related features (windshield wipers, headlights, display . . . ) being associated with a second clock position (e.g., 3:00). The different intended effects may be differentiated with selection of different contact gestures (e.g., at a clock position: tapping for on/off control; two finger magnification/contraction for controlling volume; swiping for changing channels, . . . ).

FIGS. 33-36 are representative examples of zonal reassignment by the subject invention. With reference to FIG. 33, in the leftmost representation of the steering wheel 100, the currently active zone Z_{active} is identified as Z8 (zone 8). With counterclockwise angular displacement of the steering wheel 100, the currently active zone Z_{active} is identified as Z6 (zone 6). With further clockwise angular displacement of the steering wheel 100, the currently active zone Z_{active} is identified as Z1 (zone 1). Notably, the currently active zone Z_{active} is continuously at the same position (12:00 position) regardless of the angular displacement of the steering wheel 100. Different zones are associated with the currently active zone Z_{active} to continuously provide a fixed-location for user input. This allows for a user to apply gestures to a fixed location regardless of steering wheel position. This is particularly advantageous to minimize driver distraction. In addition, gesture input is simplified without the need for determining input location, which allows for rapid entry. For example, single-touch use by first responders for emergency calls.

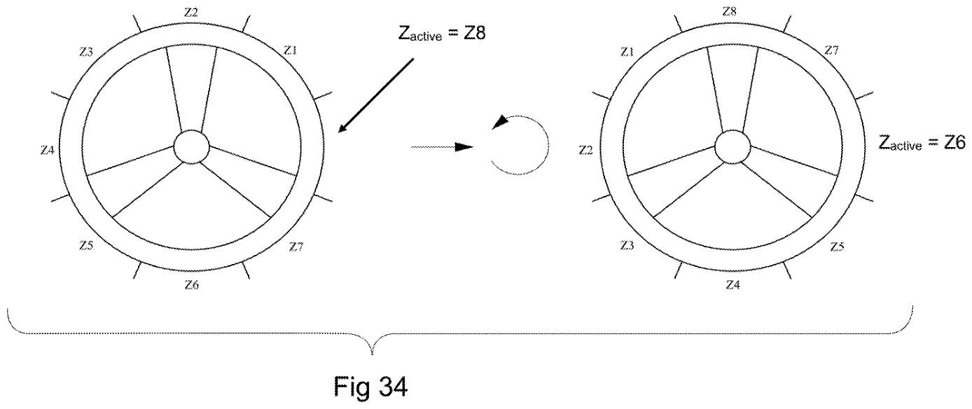

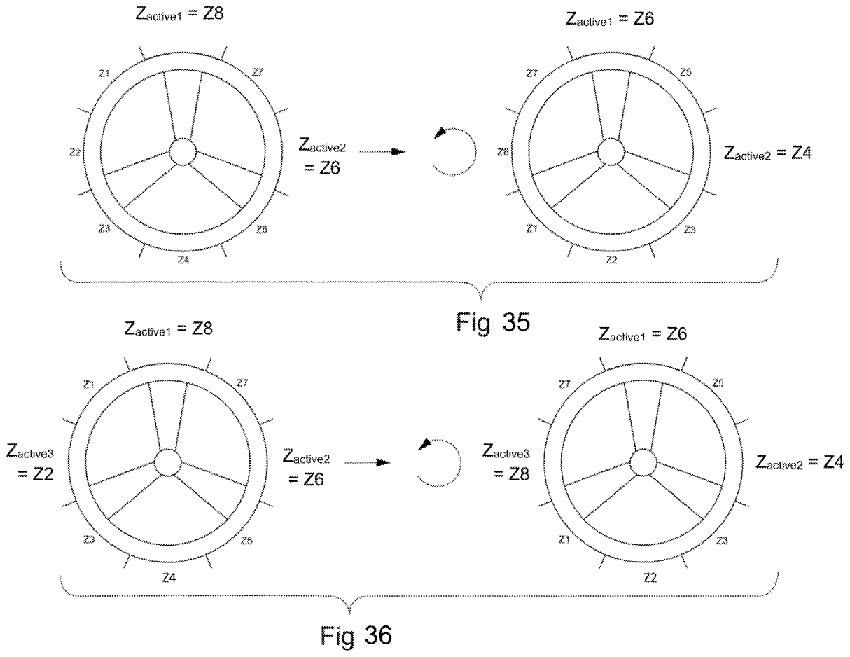

FIG. 34 shows the currently active zone Z_{active} being located at the 3:00 position to show that the fixed position may vary. Regardless that the fixed position is located differently, the operation is the same with reassignment of the currently active zone Z_{active} from Z8 (zone 8) to Z6 (zone 6).

FIGS. 35 and 36 show multiple currently active zones Z_{active1}, Z_{active2}, Z_{active3} at different locations with zonal reassignment based on angular displacement of the steering wheel 100. This shows that zonal reassignment may be in parallel. The multiple currently active zones Z_{active1}, Z_{active2}, Z_{active3} may be associated with different intended effects, thereby allowing for control over different features or elements in parallel. It is possible to associate the same intended effect with more than one currently active zone Z_{active1}, Z_{active2}, Z_{active3}, e.g., if the intended effect is of significant import, there is concern over use by a driver due to dominance of a hand (right-handed versus left-handed operation), and so forth.

What is claimed is:

1. A method of accepting user inputs on a steering wheel assembly during use, the steering wheel assembly including a touch-detectable steering wheel element mounted on, or integrated with, a steering wheel, the method comprising:
i. associating a first output signal with i. a first intended effect and ii. one or more contact gestures;
ii. associating the first output signal with a first clock position relative to the steering wheel;
iii. continuously monitoring angular displacement of the steering wheel during use;
iv. identifying, based on the angular displacement of the steering wheel, a currently active zone of the touch-detectable steering wheel element which is, at a given moment, in alignment with the first clock position; and,
v. upon being identified, associating the currently active zone with the first output signal such that application of the one or more contact gestures by the user within the currently active zone is translatable into generation of the first output signal,
wherein, steps iv. and v. are iteratively repeated.

2. The method of claim 1, further comprising transmitting the generated first output signal.

3. The method of claim 1, wherein the first intended effect may be selected from one or more of: control over one or more vehicle features; control over one or more vehicle displays; control over one or more vehicle elements; and, control over communication with third parties.

4. The method of claim 1, wherein the one or more contact gestures may be selected from: single finger contact, multi-finger contact, single finger tapping, multi-finger tapping, grasping, swiping, two finger magnification, two finger contraction, hand gestures, and palm gestures.

5. The method of claim 1, wherein the currently active zone overlaps the first clock position.

6. The method of claim 5, wherein the currently active zone extends circumferentially from the first clock position.

7. The method of claim 1, further comprising:
vi. associating a second output signal with i. a second intended effect and ii. one or more secondary contact gestures;
vii. associating the second output signal with a second clock position relative to the steering wheel;
viii. identifying, based on the angular displacement of the steering wheel, a second currently active zone of the touch-detectable steering wheel element which is, at a given moment, in alignment with the second clock position; and,
ix. upon being identified, associating the second currently active zone with the second output signal such that application of the one or more secondary contact gestures by the user within the second currently active zone is translatable into generation of the second output signal,
wherein, steps viii. and ix. are iteratively repeated.

8. The method of claim 7, wherein the second clock position is distinct from the first clock position.

9. The method of claim 8, wherein the second intended effect is distinct from the first intended effect.

10. A steering wheel assembly comprising:
a rotatable steering wheel, wherein a series of stationary virtual zones encircle the steering wheel;
a touch-detectable steering wheel element mounted on, or integrated with, the steering wheel, wherein the touch-detectable steering wheel element includes a plurality of sensors configured to detect contact of the touch-detectable steering wheel element by a user, the plurality of sensors being divided into a plurality of zones configured to independently detect contact by a user, the plurality of zones being movable relative to the virtual zones with angular displacement of the steering wheel;
a detector configured to detect angular displacement of the steering wheel; and,
a central processor configured to:
i. at initiation of a session of use of the steering wheel, determine which of the plurality of zones is initially associated with a first virtual zone of the virtual zones by one of:
a. identifying an initially-associated zone as the zone of the plurality of zones which is aligned with the first virtual zone at the initiation of the session of use; or,
b. identifying an initially-associated zone based on a predefined default setting;
wherein, a first output signal is associated with the first virtual zone, and,
wherein, the initially-associated zone is associated with the first output signal, to the exclusion of the other zones, such that contact by the user of the initially-associated zone in a predetermined manner is translatable into generation of the first output signal; and,
ii. during the session of use of the steering wheel, based on the detected angular displacement of the steering wheel, identify a currently active zone, the currently active zone being identified as the zone from the plurality of zones aligned, at the moment, with the first virtual zone, wherein, upon the currently active zone being identified, the currently active zone is associated with the first output signal, to the exclusion of the other zones, such that contact by the user of the currently active zone in the predetermined manner is translatable into generation of the first output signal.

11. The steering wheel assembly of claim 10, wherein the central processor is further configured to, during the session of use of the steering wheel, iteratively repeat step (iii) to identify, in real time, the currently active zone from the plurality of zones, and, for each iteration, to associate the first output signal with the currently active zone, to the exclusion of the other zones.

12. The steering wheel assembly of claim 11, wherein the step (iii) is iteratively repeated at intervals of between 0.01 seconds to 10 seconds.

13. The steering wheel assembly of claim 10, wherein the central processor is configured to:
i. at initiation of the session of use of the steering wheel, determine which of the plurality of zones is initially associated with a second virtual zone of the virtual zones by one of:
a. identifying a secondary initially-associated zone as the zone of the plurality of zones which is aligned with the second virtual zone at the initiation of the session of use; or,
b. identifying a secondary initially-associated zone based on a predefined default setting;
wherein, the second virtual zone is distinct from the first virtual zone,
wherein, a second output signal is associated with the second virtual zone, and,
wherein, the secondary initially-associated zone is associated with the second output signal, to the exclusion of the other zones, such that contact by the user of the secondary initially-associated zone in a predetermined manner is translatable into generation of the second output signal; and,
iii. during the session of use of the steering wheel, based on the detected angular displacement of the steering wheel, identify a secondary currently active zone, the secondary currently active zone being identified as the zone from the plurality of zones aligned, at the moment, with the second virtual zone, wherein, upon the secondary currently active zone being identified, the secondary currently active zone is associated with the second output signal, to the exclusion of the other zones, such that contact by the user of the secondary currently active zone in the predetermined manner is translatable into generation of the second output signal.

14. The steering wheel assembly of claim 10, wherein the contact by the user in the predetermined manner is by one or more of: single finger contact; multi-finger contact; single finger tapping; multi-finger tapping; grasping; swiping; two finger magnification; two finger contraction; hand gestures; and, palm gestures.

15. The steering wheel assembly of claim 10, wherein at least one zone of the plurality of zones is configured to detect the extent of grip by the user of the steering wheel.

16. The steering wheel assembly of claim 10, wherein at least one zone of the plurality of zones is inactive with no touch detection.

17. The steering wheel assembly of claim 10, wherein the detector includes an inertial measurement unit.

18. The steering wheel assembly of claim 10, wherein the first output signal is associated with a first intended effect from one or more of: control over one or more vehicle features; control over one or more vehicle displays; control over one or more vehicle elements; and, control over communication with third parties.
